(19) United States
(12) Patent Application Publication
(10) Pub. No.: US 2012/0047247 A1
(43) Pub. Date: Feb. 23, 2012

(54) SYSTEM AND METHOD FOR ALLOWING DATA TRAFFIC SEARCH

(75) Inventor: Philippe P. Piernot, Palo Alto, CA (US)

(73) Assignee: OPENWAVE SYSTEMS INC., Redwood City, CA (US)

(21) Appl. No.: 12/858,675

(22) Filed: Aug. 18, 2010

(51) Int. Cl. G06F 15/173

(52) U.S. Cl. 709/224

(57) ABSTRACT

A system and method for allowing data traffic search involves capturing data traffic to and from a user device on at least one communication path between the user device and end devices and indexing data of the captured data traffic based on parameters, wherein the data of the captured data includes data of different types of data traffic with respect to at least one of protocol and application. As a result, the system and method allows a user to search the indexed data for the different types of data traffic to and from the user device.

### BACKGROUND

Internet-enabled computing devices, such as personal computers and smartphones, are widely used to connect to the Internet to access various network resources that are available on the Internet, such as documents, videos, audio files, and webpages, using a web browser. In addition to connecting to the Internet, these computing devices are widely used to communicate with other computing devices using various communications, such as telephone calls, instant messages, emails and short message service (SMS) and multimedia messages (MMS) messages. Furthermore, these computing devices can also be used to run proprietary applications to access information, which may be downloaded from external servers via the Internet. Thus, a significant amount of data is transmitted to and from the computing devices.

When users want to search for certain data transmitted from their computing devices or received at their computing devices, the users have limited searching tools at their disposal. If a user wants to find a particular email, then an email application running on the user's computing device may be used to search for that email. If the user wants to find a particular webpage that was previously visited, then a desktop search engine on the user's computing device may be used to search for that webpage, which may have been cached.

A concern with these conventional searching tools is that multiple applications or search engines may be needed to search data for different applications, which requires the users to remember which application corresponds to the data being searched. In addition, these conventional searching tools cannot be used to search all data transmitted to and from computing devices.

In view of the above concerns, there is a need for a data search system and method that can eliminate these concerns.

### SUMMARY

A system and method for allowing data traffic search involves capturing and optionally tagging data traffic to and from a user device on at least one communication path between the user device and end devices and indexing data of the captured data traffic based on parameters, wherein the data of the captured data includes data of different types of data traffic with respect to at least one of protocol and application. As a result, the system and method allows a user to search the indexed data for the different types of data traffic to and from the user device.

A data traffic search system in accordance with an embodiment of the invention comprises a data traffic extraction module, an indexing module, a data traffic search engine and an application programming interface. The data traffic extraction module is operably connected to at least one communication path between a user device and end devices. The data traffic capturing module is configured to capture data traffic to and from the user device on the at least one communication path. The indexing module is operably coupled to the data traffic extraction device. The indexing module is configured to index data of the captured data traffic based on parameters into indexed data. The data of the captured data traffic includes data of different types of data traffic with respect to at least one of protocol and application. The indexing module is further configured to store the indexed data in at least one memory. The data traffic search engine is connected to the at least one memory to execute a requested search on the indexed data. The application programming interface is operably coupled to the data traffic search engine to allow a requesting device to search the indexed data using the data traffic search engine to find specific data of the data traffic to and from the user device. The operations of the data traffic extraction module, the indexing module, the data traffic search engine and the application programming interface are executed using one or more processors.

A method for allowing data traffic search in accordance with an embodiment of the invention comprises capturing data traffic to and from a user device on at least one communication path between the user device and end devices, indexing data of the captured data traffic based on parameters into indexed data, the data of the captured data traffic including data of different types of data traffic with respect to at least one of protocol and application, storing the indexed data in memory, receiving a search request from a requesting device to search the indexed data for specific data of the data traffic to and from the user device, and executing a search on the indexed data in the memory using a data traffic search engine in response to the search request to find the specific data of the data traffic to and from the user device as defined in the search request.

A method for allowing data traffic search in accordance with another embodiment of the invention comprises capturing all data traffic to and from a user device on at least one communication path between the user device and end devices, indexing at least some data of the captured data traffic based on parameters into indexed data, storing the indexed data in memory, receiving a text search request from a requesting device to search the indexed data for textual content of the data traffic to and from the user device, and executing a search on the indexed data in the memory using a data traffic search engine in response to the text search request to find the data of the data traffic to and from the user device containing the textual content as defined in the search request.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of a networked environment within a data traffic search system in accordance with an embodiment of the invention.

FIG. 2 depicts a schematic block diagram of components of the data traffic search system in accordance with an embodiment of the invention.

FIG. 3 depicts a schematic block diagram of a networked environment with the network data traffic search system located in user devices in accordance with an embodiment of the invention.

FIGS. 4A and 4B depict schematic diagrams of communications through the network data traffic search system in accordance with embodiments of the invention.

FIG. 5 depicts a diagram illustrating the different types of data traffic that are captured, indexed and made searchable by the data traffic search system in accordance with an embodiment of the invention.

FIG. 6 depicts a schematic diagram of the data traffic search system in a mobile network environment in accordance with an embodiment of the invention.

FIG. 7 is a flow diagram of a method for allowing data traffic search in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

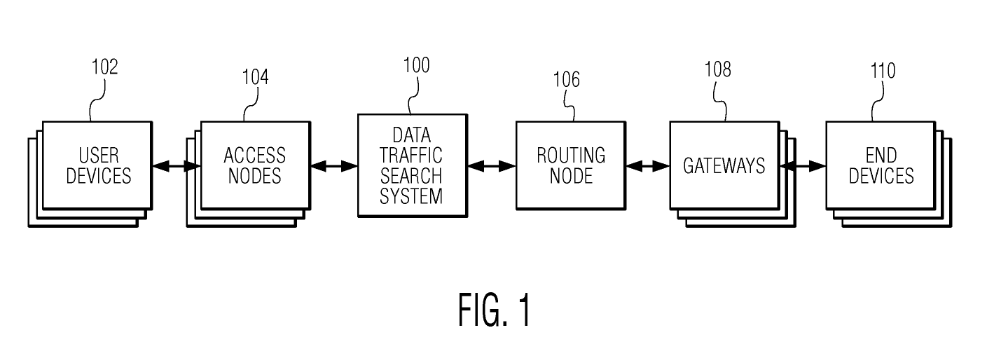

With reference to FIG. 1, a networked environment that includes a data traffic search system 100 in accordance with an embodiment of the invention is shown. As described in more detail below, the networked environment further includes user devices 102, access nodes 104, gateways 108, and end devices 110, and may also include a routing node 106 as depicted in FIG. 1. However, the routing node may also be optional and any routing functionality, if necessary, may be provided by any other device.

In the example of FIG. 1, the data traffic search system 100 facilitates searches based on communications between the user devices 102 and the end devices 110. In particular, the data traffic search system allows searches on data traffic to and from specific users and/or specific user devices. Communications between the devices in the networked environment may be carried out using a communication interface, such as analog modem, ISDN modem or terminal adapter, cable modem, Ethernet/IEEE 802.3 interface, wireless 802.11 interface, WiMAX/IEEE 802.16 interface, Bluetooth interface, cellular/mobile phone interface, general packet radio service (GPRS) interface, Enhanced GPRS (EDGE/EGPRS), third generation (3G) mobile phone interface, High-Speed Packet Access (HSDPA/HSUPA/EUL) interface, Evolution-Data Optimized (EVDO) interface, code division multiple access (CDMA) interface, fourth generation (4G LTE/WiMAX) mobile phone interface, and other interfaces for communicating between networked devices, or any combination thereof

The user devices 102 may be any networked device including, without limitation, mobile phones, smart phones, personal digital assistants (PDAs), tablets, set-top boxes, video players, laptops, or personal computers (PCs). The user devices may be configured to send and receive data traffic including, without limitation, voice data, short message service (SMS) and multimedia message service (MMS) messages, instant messaging (IM) messages, emails, webpages, images (JPEG, TIFF, PDF), proprietary application data, or any other packet-switched or circuit-switched data through one or more gateways 108. The proprietary application data may be data for proprietary applications specially designed to run in mobile communication devices, e.g., smartphones, which access information from the Internet for certain operations.

The access nodes 104 may include, without limitation, cell towers, such as base transceiver stations (BTS), Wi-Fi access point, or hubs. Each of the gateways 108 may be any device that interconnects two or more networked devices and transfers packets of data between the networked devices. In a non-limiting example, the gateway may be a gateway GPRS support node (GGSN), a mobile switching center (MSC), a short message mobile switching center (SMS-MSC), a router, a Wi-Fi access point, a web proxy, a mail server, a load balancer, a mobile phone, a personal computer, or any combination thereof

Data traffic may be routed to different gateways 108 depending on the type of data in the data traffic and/or the protocol used by the data traffic. For example, in mobile devices, voice related data may be routed to a mobile switching center, whereas web related data may be routed to a gateway GPRS support node. Routing can be done in the data traffic search system 100 or in the routing node 106 located in the network path between the user devices 110 and the gateways 108, which are capable of transcoding the data sent from the user devices 102 to the end devices 110 into protocols that can be understood by the end devices (and vice versa for data sent from the end devices to the user devices). In a mobile network environment, the routing node may be a service GPRS support node (SGSN) or gateway GPRS support node (GGSN) in an exemplary embodiment of a 3G network environment, or a packet data network (PDN) in an exemplary embodiment of a 4G network environment.

The end devices 110 may be a web server, an email server, a mobile phone, a personal computer, or any other device capable of sending or receiving data to/from the user devices 102. The end devices may be coupled to the gateways 108 via a packet-switched network, such as a public switched data network (PSDN), a circuit-switched network, such as a public switched telephone network (PSTN), a short message service center (SMSC), a web server, a mail submission agent (MSA), a mail delivery agent (MDA), or any combination thereof.

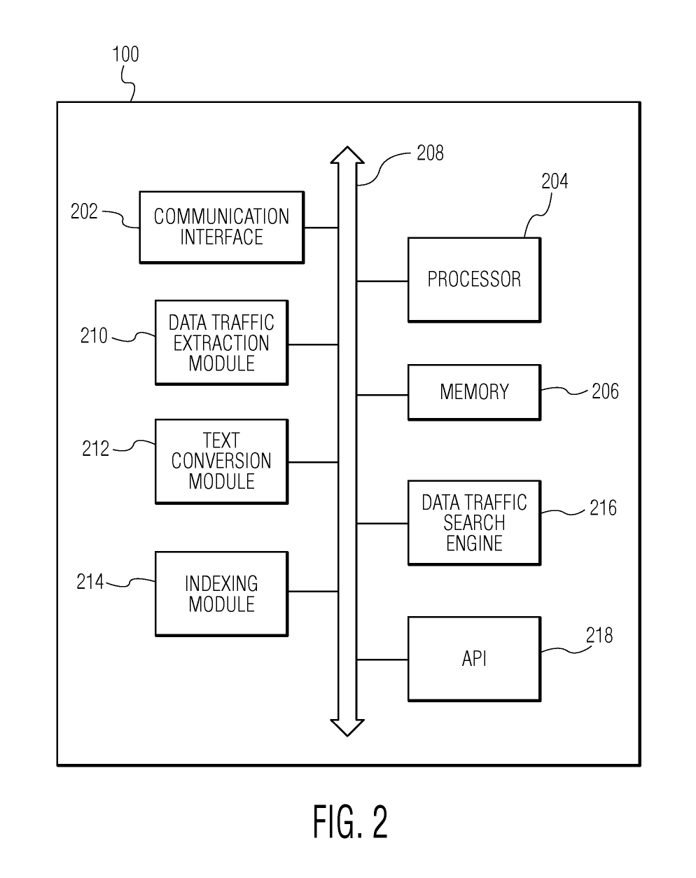

In the example of FIG. 1, the data traffic search system 100 is located between the user devices 102 and the gateways 108 in the networked environment, and more particularly between the access nodes 104 and the routing node 106. However, the data traffic search system may be located anywhere on the data traffic communication path between the user devices and the end devices 110. The data traffic search system may be a stand-alone device, a component of a stand-alone device, part of at least one of the access nodes, part of at least one of the routing nodes 106, part of at least one of the gateways 108, or may be part of any device connected to the data traffic communication path between the user devices and the end devices. Thus, the data traffic search system can reside in a single device or may be distributed over more than one device connected to the data traffic communication path between the user devices and the end devices. As an example, the data traffic search system may reside in a WiFi access point or cable/DSL modem that connects to various devices, such as set-top boxes via wireless or wired connection, e.g., Ethernet. In one embodiment, the data traffic search system may be part of the user devices, as will be described in more detail below with reference to FIG. 2. The data traffic search system may capture all incoming and outgoing data traffic between the user devices and the end devices. In one embodiment, the data traffic is not stopped by the data traffic search system but is seamlessly copied without interrupting the flow of data traffic. In the example of FIG. 1, the data traffic search system indexes the data traffic and makes the indexed data traffic searchable. The data traffic may be indexed based on textual data included in files of the data traffic, on text deduced from an image file (e.g. using optical character recognition (OCR) on a JPEG or PDF file), or on text deduced from voice (e.g. using speech to text or keyword spotting). Contextual metadata may be applied to the indexed data traffic and the metadata may include the time/date, the source/origin (e.g. sender/receiver of a message), the device type of the source/origin, the specific access node through which data traffic passed (e.g. using a cell tower identification (ID)), data type, application ID, protocol type, device sensor information (e.g. ambient light level, sound level, GPS data, accelerometer data, battery level, signal level etc.) or any other information allowing a user to perform contextual search on the indexed data traffic. The metadata may also include any data the data traffic search system may gather via web application programming interfaces (APIs), such as weather and traffic conditions. The indexed data traffic may be stored in the data traffic search system or may be stored in another network or in the “cloud”. The indexed data traffic can be made accessible to users through the data traffic search system or through any other interface.

In one embodiment, the data traffic is indexed for each specific user device. That is, all or parts of the data traffic going through the specific user device will be indexed and matched to that specific user device. The device may be identified by, for example, an international mobile equipment identity (IMEI), a mobile access control (MAC) address, or an internet protocol (IP) address. A user of the specific user device may then search the data traffic of that specific user device. In another embodiment, the data traffic is indexed and matched to a particular user rather than to a specific user device. A particular user may be identified by login credentials (e.g. for a proxy server), an international mobile subscriber identity (IMSI), an email address, an IP address, or a phone number. The particular user can use the login credentials to login to the data traffic search system and can search the indexed data traffic to which the particular user is assigned. In this embodiment, the search may be done from any user device, as long as the particular user possesses the appropriate login credentials, as will be described in more detail with reference to FIG. 2.

If the user device 102 uses different routing nodes to connect to gateways, such as when the user device switches from a 3G connection to a Wi-Fi connection, it is preferable that the data traffic search system 100 is located in the user device, such that the data traffic search system captures and indexes data traffic going through both routing nodes (for example an SGSN and a Wi-Fi router). Alternatively, if the data traffic search system is located in a particular network, such as, for example, a mobile network including the SGSN, and the user device is connected to a Wi-Fi network, the user device may force proxying of the data traffic to the data traffic search system in the mobile network.

The user of the user device 102 may chose what data traffic to index, and how to index the data traffic. For example, the user can chose to only allow indexing of certain data packet types/files/protocols and chose the length of time the indexed data is kept at the data traffic search system 100. In one embodiment, the data traffic search system 104 includes an API allowing the user of the user device 102 to access the data traffic search system and configure how data traffic from the user device is indexed.

In one embodiment, data traffic going through the user devices 102 connected to the access nodes 104 is captured and indexed by the data traffic search system 100 using, as one of the parameters for indexing the data traffic, identifiers for the access nodes. In this manner, it is possible to allow searching of data traffic that passed through a particular access node from all or selected user devices connected to that access node. The indexed data traffic may be searched from any device connected to the data traffic search system, not only from the user devices.

Turning now to FIG. 2, a schematic block diagram of components of the data traffic search system 100 in accordance with an embodiment of the invention is shown. As shown in FIG. 2, the data traffic search system includes a communication interface 202, at least one processor 204 and at least one memory 206 that are connected to a data bus 208. The communication interface enables communications with other devices, such as components of the user devices 102, via, for example, Internet Protocol (IP). The processor may include a multifunction processor and/or an application-specific processor. The processor can be any processor commonly found in a server. The memory can be any type of computer memory, such as read only memory (ROM), flash memory, random access memory (RAM) or a hard disk drive.

The data traffic search system 100 further includes a data traffic extraction module 210, an optional text conversion module 212, an indexing module 214, a data traffic search engine 216 and an application programming interface (API) 218. Devices and modules of the data traffic search system may reside in a same device or may be distributed over different devices. In the example of FIG. 2, the data traffic extraction module is configured to capture data of the data traffic transmitted to and from the user devices 102 on at least one communication path between the user devices and the end devices 110. The data traffic extraction module may capture the data of the data traffic by receiving the data from one or more network probes monitoring the communication paths between the user devices and the end devices. Alternatively, the data traffic extraction module may capture the data of the data traffic by receiving the data from one or more network components that facilitates data traffic between the user devices and the end devices. The indexing module is configured to index the captured data as indexed data, which is then stored in an index database in the memory 206 or any other memory or storage device accessible by the data traffic search system. The data traffic search engine is configured to perform contextual searches using the indexed data in response to user requests via the API. Thus, the API is used by authorized users to interface with the data traffic search system to perform data traffic searches. The API may also be used to define how the data traffic is indexed for each of the authorized users or user devices. The optional text conversion module is configured to convert text-containing images (i.e., images with textual information) or voice information (i.e., spoken words) in the captured data into text so that textual information in the captured data can be indexed and searched, as well. In one embodiment, the optional text conversion module provides automatic close-captioning and/or text extraction (OCR) from video frames.

In an embodiment, the data traffic extraction module 210, the text conversion module 212, the indexing module 214 and the data traffic search engine 216 are implemented as software stored in a computer readable medium, such as the memory 206, which is executed by the processor 204 to perform the operations of these components. However, in other embodiments, each of the data traffic extraction module, the text conversion module, the indexing module and the data traffic search engine may be implemented in any combination of software, firmware and hardware. In some embodiments, the data traffic search system may be implemented as one or more servers with the data traffic extraction module, the text conversion module, the indexing module and the data traffic search engine residing in one or more of these servers. The data traffic search system 100 may additionally use previously stored and indexed data (or data stored and indexed through other means) and allow users to search data captured through the data traffic search system along with previously stored and indexed data in a unified manner (e.g. via an API).

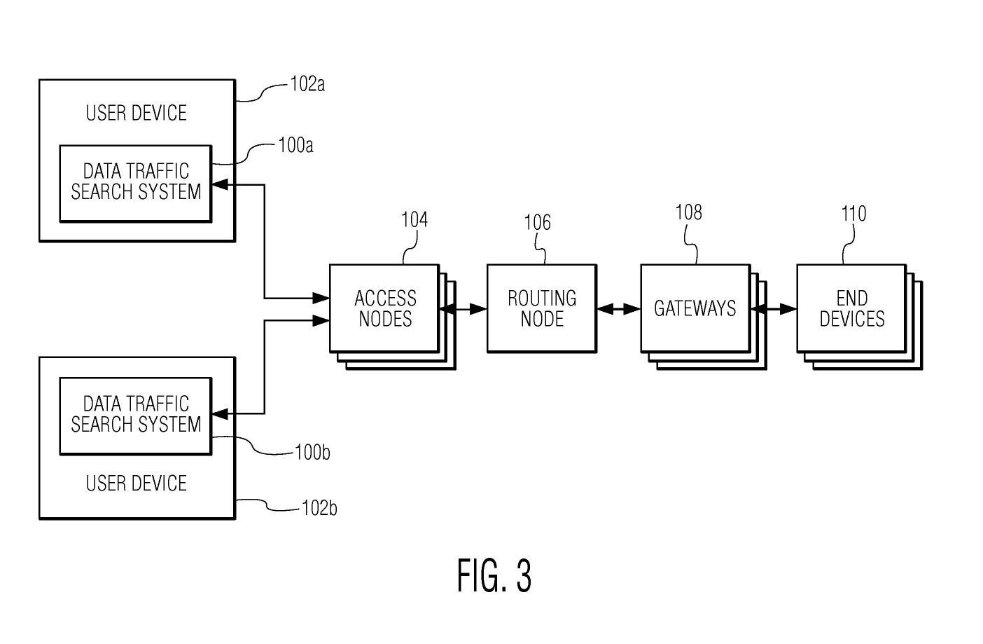

Turning now to FIG. 3, a networked environment that includes the data traffic search systems in user devices in accordance with another embodiment of the invention is shown. In FIG. 3, the reference numbers used in FIG. 1 are used to indicate similar components. As shown in FIG. 3, the networked environment includes data traffic search systems 100a and 100b, which are located in user devices 102a and 102b, respectively. Thus, each of these user devices is assigned to a specific data traffic search system. In one embodiment, each of the data traffic search systems may be implemented in software and executed by the processor of the user device in which that data traffic search system is located. However, in other embodiments, each of the data traffic search systems may be implemented in any combination of software, hardware and firmware.

In this embodiment, the data traffic search system 100a operates to capture incoming and outgoing data traffic of the user device 102a. Similarly, the data traffic search system 100b captures incoming and outgoing data traffic of the user device 102b. Searches on data traffics through the user devices 102a and 102b may be performed using the data traffic search systems 100a and 100b, respectively. Including the data traffic search systems in the user devices allows for searching on past data traffic even if the user devices are no longer connected to the gateways 108.

In one embodiment, the networked environment may further optionally comprise a centralized network data traffic search system (not shown) located between the user devices 102a and 102b and the gateways 108. The network data traffic search system may synchronize the data traffic search systems 100a and 100b of the user devices 102a and 102b if the user devices 102a and 102b are used by a same user. In this embodiment, the network data traffic search system allows the user to search all data traffic that went through both user devices. Additionally, the user may also search all indexed data traffic of the user devices 102a and 102b from a third device (not shown) using, for example, login credentials to access the network data traffic search system.

In the following, an illustrative and non-limiting example is described for the user device 102a switching between a Wi-Fi network and a 3G network, where the 3G network includes the network data traffic search system. If the user device 102a is temporarily connected to a gateway of the Wi-Fi network not connected to the network data traffic search system, the user device 102a stores the indexed data traffic going through the Wi-Fi network in the device data traffic search system 100a. Upon the next connection to the 3G network, the data traffic search system 100a of the user device 102a synchronizes the indexed data traffic with the previously indexed data traffic stored in the network data traffic search system, allowing the user to search all indexed data traffic (through both the Wi-Fi and 3G network) for the user device 102. The search may be performed using the user device 102a or from other devices associated with the user, such as the user device 102b.

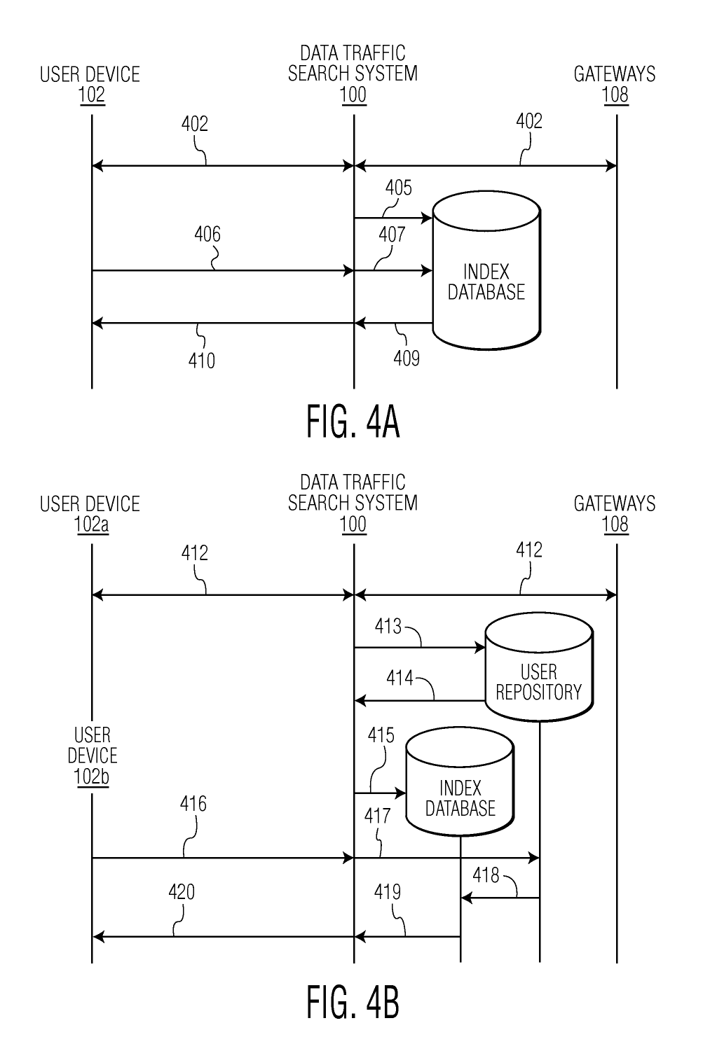

Turning now to FIGS. 4A and 4B, communications through the data traffic search system 100 in accordance with embodiments of the invention are shown. In the example of FIG. 4A, data traffic occurs between a user device 102 and gateways 108 at step 402. The data traffic search system extracts the data traffic from one or more signal paths between the user device and the gateways. Upon extracting the data traffic, the data traffic search system indexes the data traffic and stores the indexed data traffic in an index database at step 405. In some embodiments, the data traffic search system, i.e., the indexing module 214, may add metadata to the indexed data. The added metadata may include information from the user device or from any other source within the communication path between the user device and end devices connected to the gateways. The index database may be located in the data traffic search system or may be located external to the data traffic search system. When the user device performs a search on the data traffic, a search query is sent to the data traffic search system at step 406. Accordingly, a request is sent at step 407 from the data traffic search system to the index database to fetch the indexed data traffic and the results relating to the search query are received at the data traffic search system at step 409. The data traffic search system may perform additional formatting and send the results to the user device at step 410. As noted above, in some embodiments, a search request on the indexed data traffic for a particular user device may be made from a different device. In these embodiments, the search requests and the search results are transmitted between the requesting device and the data traffic search system.

In the example of FIG. 4B, data traffic occurs between a user device 102a and gateways 108 at step 412. The data traffic search system 100 extracts the data traffic from one or more signal paths between the user device 102a and the gateways. Using information in the data traffic, the user of the user device 102a is authenticated at steps 413 and 414, where a user repository is queried to obtained the user identity. If no user identity is available at the user repository, a new user identity associated with the user may be created. At step 415, the data traffic captured by the data traffic search system is indexed. This step may alternatively occur before the user authentication steps 413 and 414. The user, now using device 102b, sends a search query relating to the data traffic of step 412 to the data traffic search system at step 416. The user is authenticated at step 417 and the user identity is matched with the corresponding indexed data traffic at step 418. The results relating to the query of the indexed data traffic are sent to the user device 102b at steps 419 and 420.

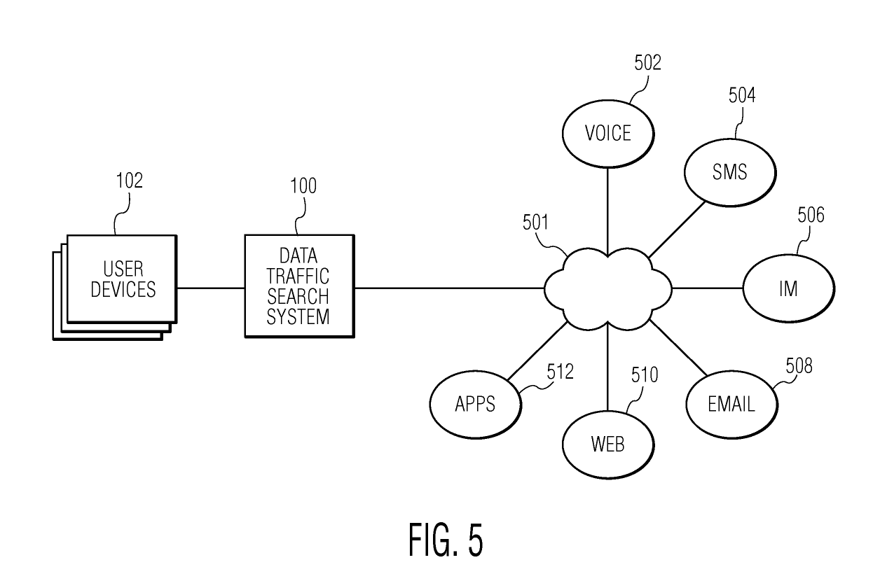

Turning now to FIG. 5, a diagram illustrating the different types of data traffic that are captured, indexed and made searchable by the data traffic search system 100 in accordance with an embodiment of the invention is shown. As shown in FIG. 5, the data traffic search system is situated in a networked environment between the user devices 100 and a network 501, which connects the user devices to a multitude of services. The multitude of services includes voice (telephony) service 502, SMS messaging service 504, IM messaging service 506, email service 508, web service 510 and proprietary application service 512. The data traffic captured, indexed, and made searchable can be both inbound with respect to the user device (e.g. a webpage) and outbound with respect to the user device (e.g. an HTTP request.)

The network 501 may include a routing node and/or gateways, where the routing node is configured to route data packets of the data traffic to the appropriate gateways of the services 502-512. Because the data traffic search system 100 is situated between the user devices 102 and the network, the data traffic search system is capable of indexing the data of the data traffic independently of the type of data present in the data traffic. For example, data associated with the voice service 502 may be used to convert at least part of the speech to text, subsequently allowing the data traffic search system to index the text associated with the speech in voice communications. Data associated with other communications, such as SMS messages, IM messages, emails, web accesses and proprietary application operations may be indexed using textual information present in these communications. A user may then perform a search on the data transmitted for these services, and the search may include contextual parameters, such as time/date, type of data, user sent to/from, and other parameters. The data associated with web accesses may include input text that was typed into a website by the user of one of the user devices 102. This input text is encoded in a Hypertext Transfer Protocol (HTTP) request and sent to a target Uniform Resource Locator (URL) of the HTTP request. The information encoded in this HTTP request, including the user generated input text, is indexed by the data traffic search system and is made searchable to the user through the user device or another associated user device, or to other authorized users, as described above with reference to FIG. 1. Additionally, the data traffic search system may query some or all storage and/or search components of the services to index and/or search data corresponding to the service.

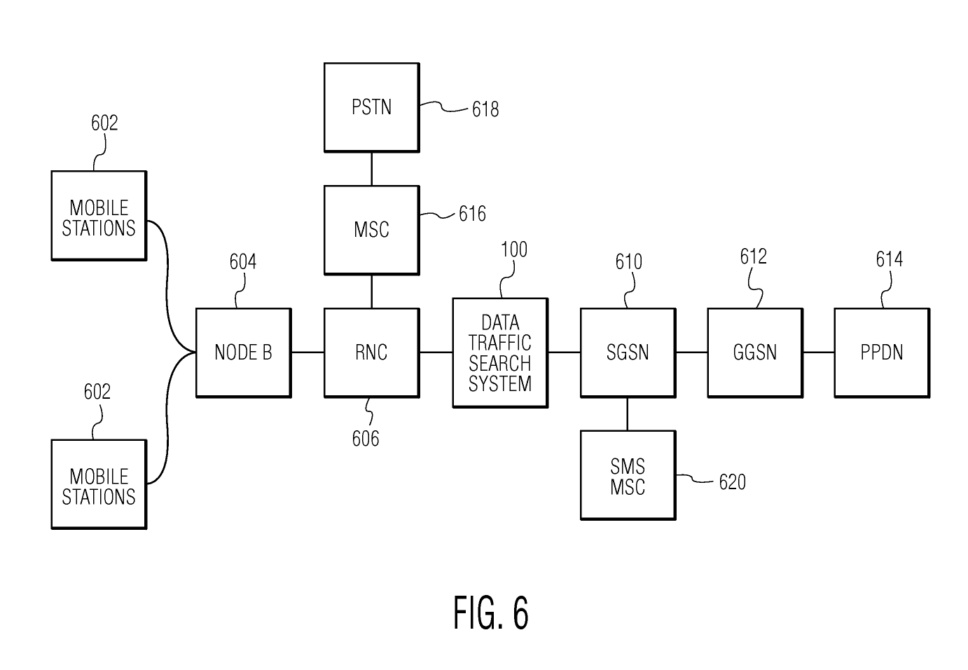

Turning now to FIG. 6, a schematic diagram of the data traffic search system 100 in a mobile network environment in accordance with an embodiment of the invention is shown. As shown in FIG. 6, the mobile network environment includes mobile stations 602, node B 604, radio network control (RNC) 606, service GPRS support node (SGSN) 610, gateway GPRS support node (GGSN) 612, public packet data network (PPDN) 614, mobile switching center (MSC) 616, the public switched telephone network (PSTN) 618, and SMS mobile switching center (SMS-MSC) 620.

The mobile stations 602 are typically handheld wireless devices, such as cell phones, mobile phones, smartphones, Personal Digital Assistants (PDA), handheld gaming devices etc, that can wirelessly communicate using radio frequency (RF) communications signals. The mobile stations can support various different RF communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), and 4G Long Term Evolution (LTE) and IEEE 802.16 standards bodies. Although some wireless communications protocols are identified herein, it should be understood that present disclosure is not limited to the cited wireless communications protocols.

The node B 604 is a network element that performs base station functionality. In an embodiment, the node B uses Wideband Code Division Multiple Access (WCDMA)/Time Division Synchronous Code Division Multiple Access (TD-SCDMA) to communicate with the mobile stations 602. In an embodiment, the node B includes an RF transceiver that communicates with the mobile stations that are within a service area of the node B. In one embodiment, the node B has a minimum amount of functionality and is controlled by the RNC 606. In another embodiment in which High Speed Downlink Packet Access (HSDPA) is used, some logic (e.g. retransmission) is handled by the node B to achieve shorter response times.

Data signals communicated between the mobile stations 602 and the node Bs 604 include, but are not limited to, analog and/or digital RF signals (i.e., radio waves) for any type of communication mode, including text messaging, multimedia messaging, voice calling, and Internet browsing. The node B can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that the present disclosure is not limited to the cited wireless communications protocols.

The RNC 606 is a network element that controls the connected node B 604. In particular, the RNC is responsible for radio resource management and mobility management. The RNC is also the element that performs encryption before user data is sent to and from the mobile stations 602. In an embodiment, radio resource management operations include outer loop power control, load control, admission control, packet scheduling, handover control, security functions, and mobility management. The RNC may also perform various radio resource optimization operations.

The SGSN 610 is a network element that delivers packets to and from the mobile stations 602 within a corresponding geographical service area. Functionality of the SGSN includes packet routing and transfer, mobility management (e.g., attach/detach and location management), logical link management, and authentication and billing. In an embodiment, the SGSN maintains a location register that stores location information, such as the current cell of a mobile station, and user profiles, such as International Mobile Subscriber Identity (IMSI) address used in the packet data network, of all GPRS mobile stations that are registered within the corresponding geographical service area of the SGSN.

The GGSN 612 is a network element that provides interworking between the GPRS network and external packet switched networks, such as the Internet and X.25 networks. In particular, the GGSN hides the GPRS infrastructure from the external networks. Some functionality of the GGSN includes checking to see if specific mobile stations are active in the radio access network and forwarding data packets to the SGSN that is currently supporting a mobile station. The GGSN also converts GPRS packets coming from an SGSN into the needed packet data protocol format (e.g., Internet Protocol or X.25) and forwards packets to the appropriate external network. The GGSN is also responsible for IP address management/assignment and is the default router for the mobile stations. The GGSN may also implement Authentication, Authorization, and Accounting (AAA) and billing functions.

The MSC 616 is a network element that provides interworking between the GPRS network and external circuit switched networks, such as the PSTN 618. The SMS-MSC 420 is a network element that provides SMS communication between mobile stations 602 in the same network or in different networks.

In the example of FIG. 6, the data traffic search system 100 receives data traffic to and from the mobile stations 602. The data traffic is indexed, as described above with reference to FIG. 1. The data traffic may include, but is not limited to: email messages, instant messages, SMS, MMS, HTML, XML, proprietary application traffic (e.g. Yelp application for mobile devices), images, voice, or any combination thereof

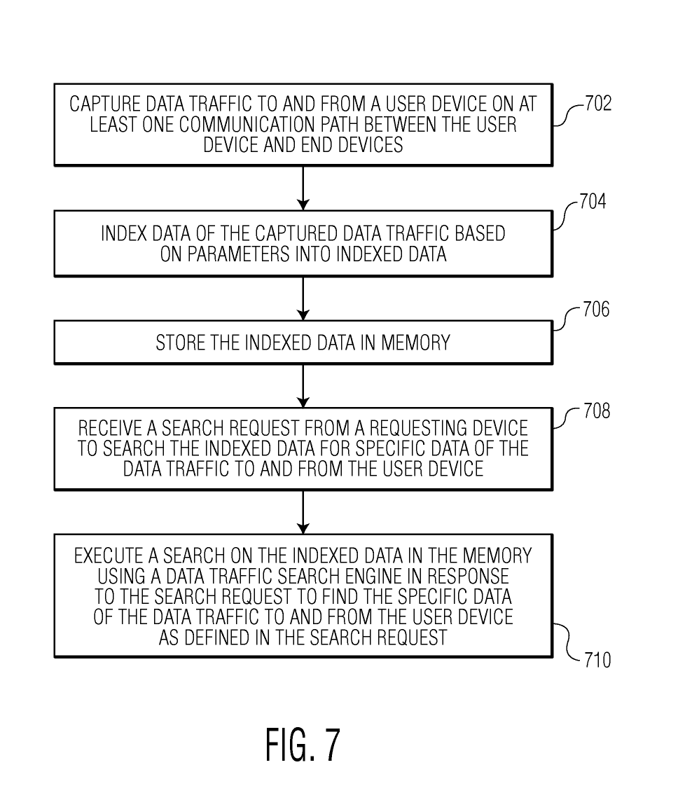

A method for allowing data traffic search in accordance with an embodiment of the invention is described with reference to a flow diagram of FIG. 7. At block 702, data traffic to and from a user device on at least one communication path between the user device and end devices is captured. At block 704, data of the captured data traffic is indexed based on parameters into indexed data. The data of the captured data traffic includes data of different types of data traffic with respect to at least one of protocol and application. In one embodiment, metadata is included in the indexed data. The metadata may include information about the data traffic and may relate to devices in the communication path between the user device and the end devices (e.g. cell ID), to the user device (e.g. GPS coordinates), to the data traffic itself (e.g. type of data), or to other parameters (e.g. date/time). At block 706, the indexed data is stored in memory. At block 708, a search request from a requesting device is received to search the indexed data for specific data of the data traffic to and from the user device. At block 710, a search on the indexed data in the memory is executed using a data traffic search engine in response to the search request to find the specific data of the data traffic to and from the user device as defined in the search request.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital versatile disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A data traffic search system comprising:
a data traffic extraction module operably connected to at least one communication path between a user device and end devices, the data traffic capturing module configured to capture data traffic to and from the user device on the at least one communication path;
an indexing module operably coupled to the data traffic extraction device, the indexing module configured to index data of the captured data traffic based on parameters into indexed data, the data of the captured data traffic including data of different types of data traffic with respect to at least one of protocol and application, the indexing module further configured to store the indexed data in at least one memory;
a data traffic search engine connected to the at least one memory to execute a requested search on the indexed data; and
an application programming interface operably coupled to the data traffic search engine to allow a requesting device to search the indexed data using the data traffic search engine to find specific data of the data traffic to and from the user device,
wherein operations of the data traffic extraction module, the indexing module, the data traffic search engine and the application programming interface are executed using one or more processors.

2. The data traffic search system of claim 1, wherein the data of the data traffic indexed by the indexing module includes data from proprietary application traffic for proprietary applications running on the user device so that the data traffic search engine can search the data from the proprietary application traffic in response to the requested search.

3. The data traffic search system of claim 2, wherein the user device is a mobile communication device, and wherein the data from the proprietary application traffic indexed by the indexing module includes data from proprietary mobile application traffic for proprietary mobile applications running on the mobile communication device.

4. The data traffic search system of claim 2, wherein the data of the data traffic indexed by the indexing module further includes additional data from at least one of email message traffic, web traffic, text message traffic and voice data traffic so that the data traffic search engine can also search the additional data in response to the requested search.

5. The data traffic search system of claim 1, wherein the indexing module is further configured to include metadata in the indexed data.

6. The data traffic search system of claim 1, wherein the metadata includes at least one of: time/date of the data traffic, a source/origin of the data of the captured data traffic, a device type of the source/origin, a specific access node through which the data traffic passed, a cell tower identification, a data type of the captured data traffic, an application identification of an application producing the data traffic, a protocol type of the data traffic, sensor information of the user device, said sensor information including one of: ambient light level, sound level, GPS data, battery level, signal level.

7. The data traffic search system of claim 1, wherein the data traffic search system is configurable to control the type of data traffic that is captured and/or the length of time said data traffic is captured.

8. The data traffic search system of claim 1, wherein the data of the data traffic indexed by the indexing module includes text typed into a website so that the data traffic search engine can also search the typed text in response to the requested search.

9. The data traffic search system of claim 1, wherein the captured data traffic includes circuit-switched data and packet-switched data.

10. The data traffic search system of claim 1, further comprising a text conversion module operatively coupled to the data extraction module, the text conversion module configured to convert particular data of the captured data traffic to text.

11. The data traffic search system of claim 10, wherein the particular data is voice and/or audio/video data, and wherein the text conversion module is configured to convert spoken words in the voice and/or audio/video data to text.

12. The data traffic search system of claim 10, wherein the particular data is image and/or video data, and wherein the text conversion module is configured to convert textual information in the image and/or video data to text.

13. The data traffic search system of claim 10, wherein at least the data traffic capturing module is disposed in a networked environment between the user device and a gateway connected to the end users.

14. The data traffic search system of claim 1, wherein at least the data traffic extraction module is disposed in a gateway connected to the end user.

15. The data traffic search system of claim 1, wherein at least the data traffic capturing module is disposed in the user device.

16. A method for allowing data traffic search, the method comprising:
capturing data traffic to and from a user device on at least one communication path between the user device and end devices;
indexing data of the captured data traffic based on parameters into indexed data, the data of the captured data traffic including data of different types of data traffic with respect to at least one of protocol and application;
storing the indexed data in memory;
receiving a search request from a requesting device to search the indexed data for specific data of the data traffic to and from the user device; and
executing a search on the indexed data in the memory using a data traffic search engine in response to the search request to find the specific data of the data traffic to and from the user device as defined in the search request.

17. The method of claim 16, wherein the data of the indexed data traffic includes data from proprietary application traffic for proprietary applications running on the user device, and wherein the executing the search includes executing the search on the data from the proprietary application traffic in response to the requested search.

18. The method of claim 17, wherein the user device is a mobile communication device, and wherein the data from proprietary application traffic includes data from proprietary mobile application traffic for proprietary mobile applications running on the mobile communication device.

19. The method of claim 17, wherein the data of the indexed data traffic further includes additional data from at least one of email message traffic, web traffic, text message traffic and voice data traffic, and wherein the executing the search includes executing the search on the additional data in response to the requested search.

20. The method of claim 16, wherein the data of the indexed data traffic includes text typed into a website, and wherein the executing the search includes executing the search on the typed text in response to the requested search.

21. The method of claim 16, further comprising converting particular data of the captured data traffic to text, the particular data including at least one of voice data and text-containing image data, and wherein the executing the search includes executing the search on the converted text in response to the requested search.

22. A method for allowing data traffic search, the method comprising:
capturing all data traffic to and from a user device on at least one communication path between the user device and end devices;
indexing at least some data of the captured data traffic based on parameters into indexed data;
storing the indexed data in memory;
receiving a text search request from a requesting device to search the indexed data for textual content of the data traffic to and from the user device; and
executing a search on the indexed data in the memory using a data traffic search engine in response to the text search request to find the data of the data traffic to and from the user device containing the textual content as defined in the search request.

23. The method of claim 22, wherein the data of the indexed data traffic includes data from at least one of proprietary application traffic, email message traffic, web traffic, text message traffic and voice data traffic.
